(19) United States
(12) Patent Application Publication
(10) Pub. No.: US 2014/0363582 A1
(43) Pub. Date: Dec. 11, 2014

(54) METHOD OF PREPARING YTTRIA SOLUTION FOR BUFFER LAYER OF SUBSTRATE

(71) Applicant: Korea Electrotechnology Research Institute, Changwon-si (KR)

(72) Inventors: Rock-kil Ko, Changwon-si (KR); Dong-Woo Ha, Changwon-si (KR); Myung-hwan Sohn, Busan (KR); Dong-hyuk Kim, Taebaek-si (KR); Boo-min Kang, Busan (KR)

(21) Appl. No.: 13/914,788

(22) Filed: Jun. 11, 2013

(51) Int. Cl. C23C 22/73; C23C 22/02; C23C 26/00; C09D 1/00

(52) U.S. Cl. CPC C23C 22/73; C09D 1/00; C23C 22/02; C23C 26/00
USPC 427/435; 106/287.18

(57) ABSTRACT

Disclosed herein is a method of preparing a yttria solution for a buffer layer of a substrate, including the steps of: (a) mixing yttrium acetate tetrahydrate with methanol to form a mixture and then stirring the mixture; (b) injecting diethanolamine as a chelating agent into the mixture of the step (a) and then stirring the mixture to synthesize a composite; and (c) filtering the composite synthesized in the step (b) using a filter to obtain a sol. The method is advantageous in that the yttria solution prepared in this method is applied onto a substrate to flatten the substrate, and is used to form a diffusion barrier serving as a buffer layer for preventing the diffusion of a substrate material.

### FIELD OF THE INVENTION

The present invention relates to a method of preparing a yttria solution for a buffer layer of a substrate, and, more particularly, to a method of preparing a yttria solution for a buffer layer of a substrate, which is applied onto a substrate to flatten the substrate and to serve as a buffer layer.

### BACKGROUND OF THE INVENTION

Recently, with the rapid increase in demand for displays in the market, multipurpose substrates, which are fabricated by mechanical grinding, have been frequently used in the fields of materials for advanced energy technologies, such as electronic appliances, and printed circuit boards, and the like.

Such a multipurpose substrate is fabricated by rolling. This multipurpose substrate fabricated in this way is advantageous in that its manufacturing cost is low, it has a small volume and it is lightweight.

However, such a multipurpose substrate may not be used in various fields in spite of its low manufacturing cost because it does not satisfy surface roughness required for deposition of a film.

Therefore, this multipurpose substrate must be flattened. As a process of flattening the multipurpose substrate, there is mechanical grinding, electrical grinding, chemical grinding or the like. The above-mentioned processes enable the multipurpose substrate to be easily deposited with a thin film by lowering the surface roughness of the multipurpose substrate. The multipurpose substrate fabricated by mechanical grinding is frequently used in the fields of materials for advanced energy technologies, such as electrical devices (superconductors and solar batteries) and the like, displays, and printed circuit boards.

A multipurpose substrate is fabricated by conducting rolling processes several times. This method is advantageous in that the manufacturing cost of the multipurpose substrate can be reduced, the volume of the multipurpose substrate becomes small, the multipurpose substrate become light, and this method can be used together with the existing manufacturing apparatuses.

However, the multipurpose substrate may not be used in various fields in spite of its low manufacturing cost because it does not satisfy surface roughness required for deposition of a film.

Electrical grinding was developed to rapidly conduct the flattening of a long metal substrate. However, this method is problematic in that it is not suitable for flattening a desired large-area material, and it can applied to only a specific nickel compound.

Therefore, it is required to develop a method of flattening a multipurpose substrate and forming a buffer layer.

### SUMMARY OF THE INVENTION

Accordingly, the present invention has been devised to solve the above-mentioned problems, and an object of the present invention is to provide a method of preparing a yttria solution (Y2O3) using a sol-gel process, wherein the yttria solution prepared in this method is applied onto a substrate to flatten the substrate, and is used to form a diffusion barrier serving as a buffer layer for preventing the diffusion of a substrate material.

In order to accomplish the above object, an aspect of the present invention provides a method of preparing a yttria solution for a buffer layer of a substrate, including the steps of: 1) mixing yttrium acetate tetrahydrate with methanol to form a mixture and then stirring the mixture; 2) injecting diethanolamine as a chelating agent into the mixture of the step 1) and then stirring the mixture to synthesize a composite; and 3) filtering the composite synthesized in the step 2) using a filter to obtain a sol.

The step 1) may be performed at 50° C.˜60° C. for 30 minutes˜5 hours.

In the step 2), diethanolamine may be injected in an amount of 5˜20 vol % based on the volume of methanol.

In the step 2), diethanolamine may be injected using a syringe.

The step 2) may be performed at room temperature for 30 minutes˜5 hours.

In the step 3), the composite may be filtered using a syringe filter.

The sol may be deposited on a substrate.

The substrate may be a hastelloy substrate.

The deposition of the sol may be performed by dip coating.

The deposition of the sol may be performed two or more times.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a process view showing a method of preparing a yttrium solution for a buffer layer of a substrate according to the present invention;

FIG. 2 is a schematic view showing a deposition apparatus for depositing a yttria sol prepared by each Example of the present invention on a substrate;

FIG. 3 shows atomic force microscope (AFM) images of a non-surface-treated hastelloy substrate depending on surface changes thereof;

FIG. 4 shows AFM images of a substrate fabricated by Example 1 of the present invention depending on surface changes thereof;

FIG. 5 shows AFM images of a substrate fabricated by Example 2 of the present invention depending on surface changes thereof;

FIG. 6 shows AFM images of a substrate fabricated by Example 3 of the present invention depending on surface changes thereof;

FIG. 7 is a graph showing the results of auger analysis of a substrate fabricated by Example 1 of the present invention;

FIG. 8 is a graph showing the results of auger analysis of a substrate fabricated by Example 2 of the present invention;

FIG. 9 is a graph showing the results of auger analysis of a substrate fabricated by Example 3 of the present invention; and

FIG. 10 shows graphs each showing the flatness of a substrate according to the amount of diethanolamine.

### REFERENCE NUMERALS

100: substrate

200: bath

300: quartz furnace

400: tensioner

### DETAILED DESCRIPTION OF THE INVENTION

Hereinafter, preferred embodiments of the present invention will be described in detail with reference to the attached drawings.

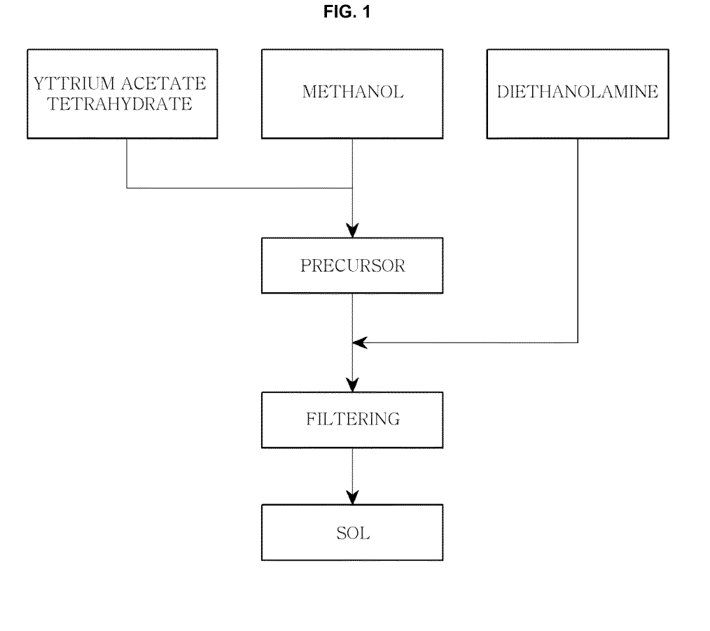

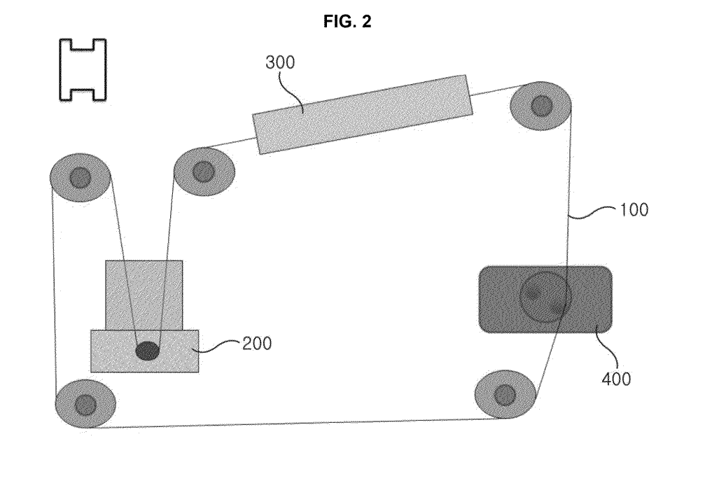

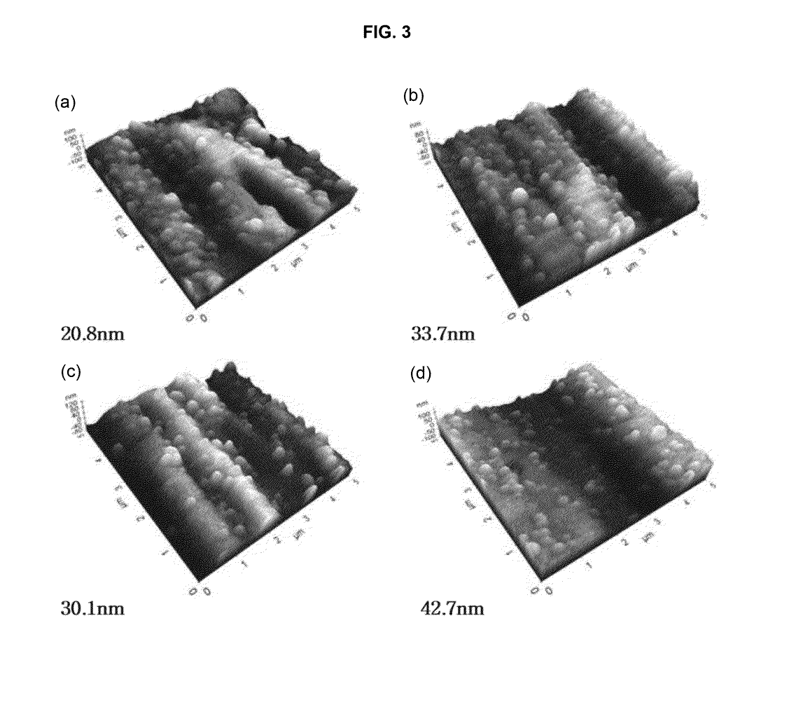

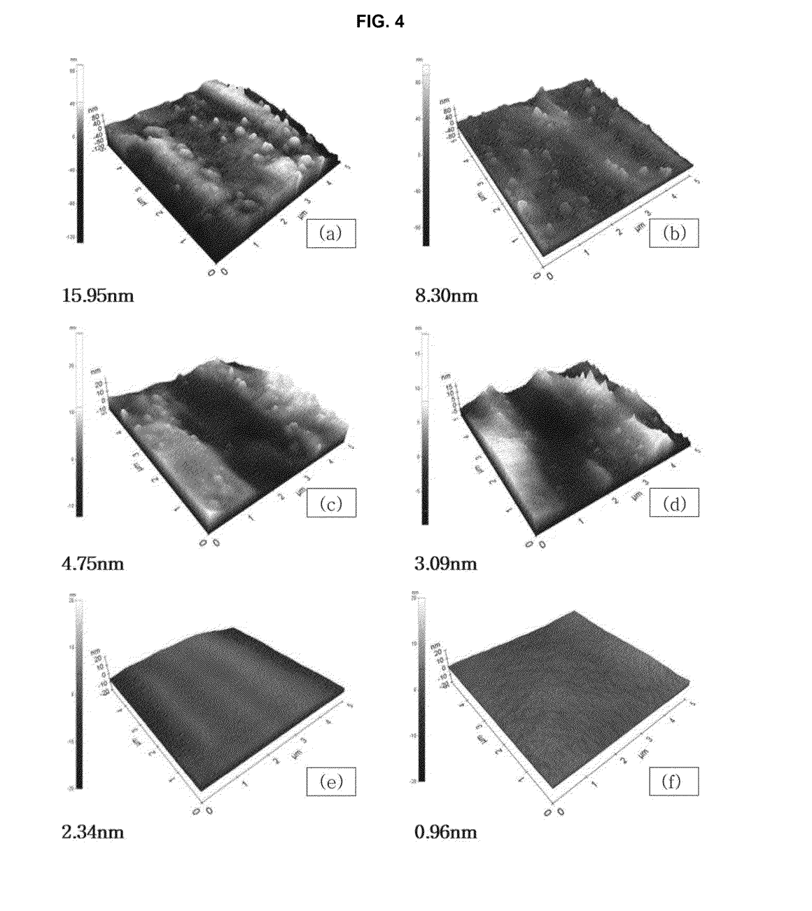

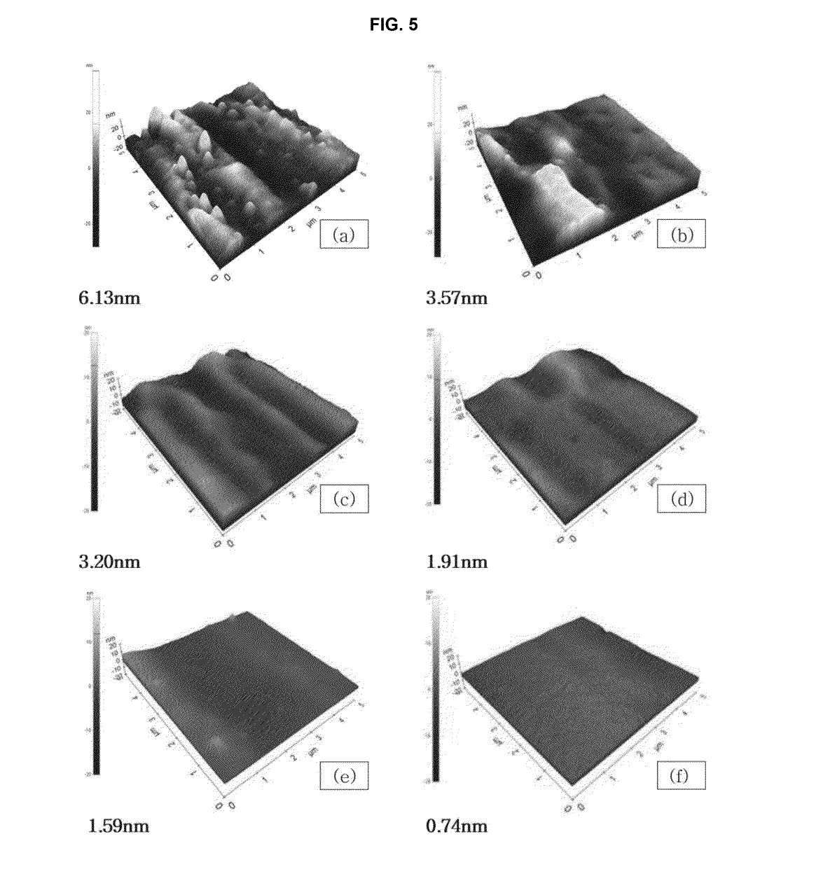

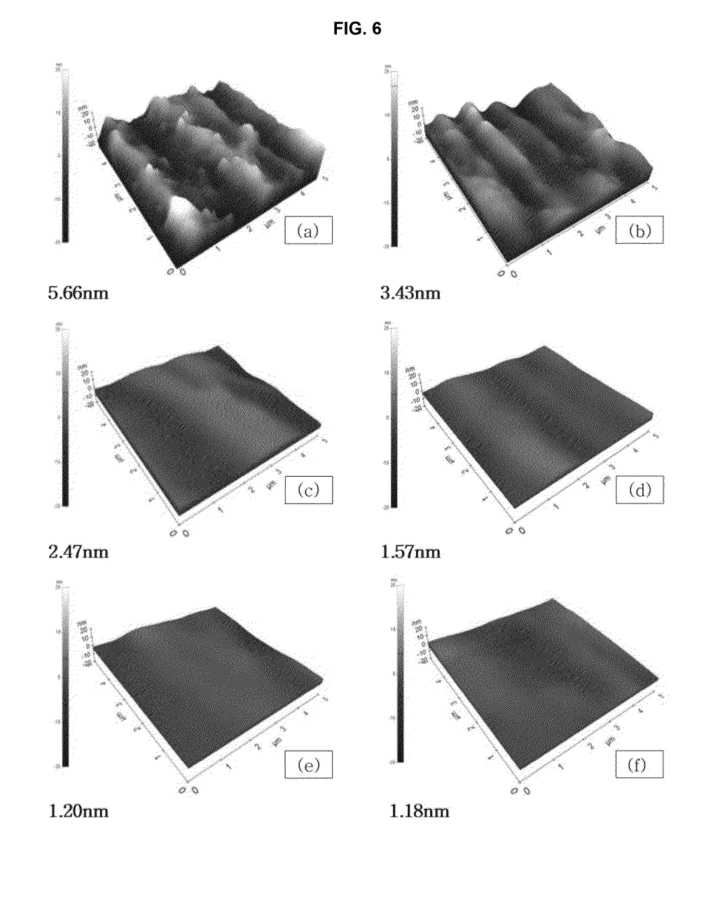

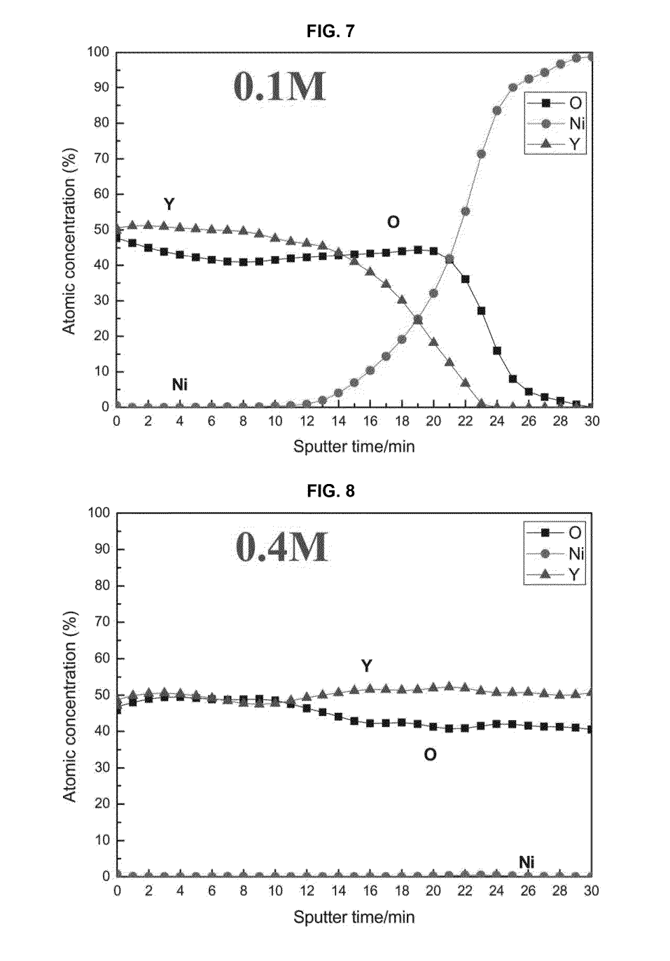

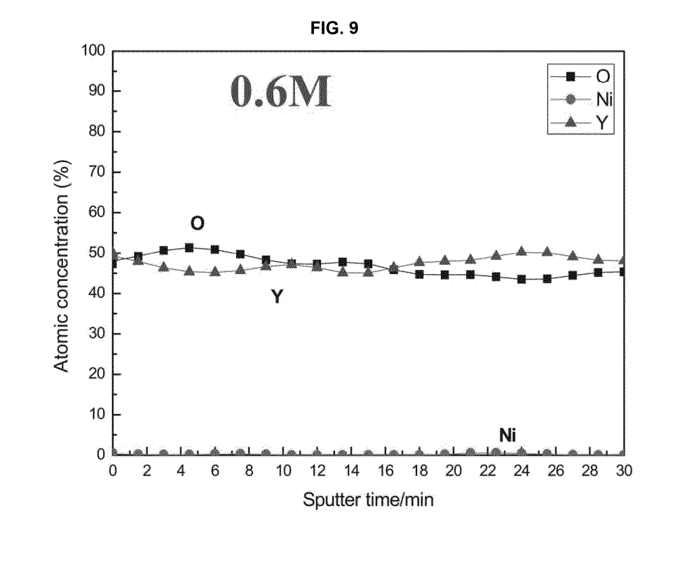

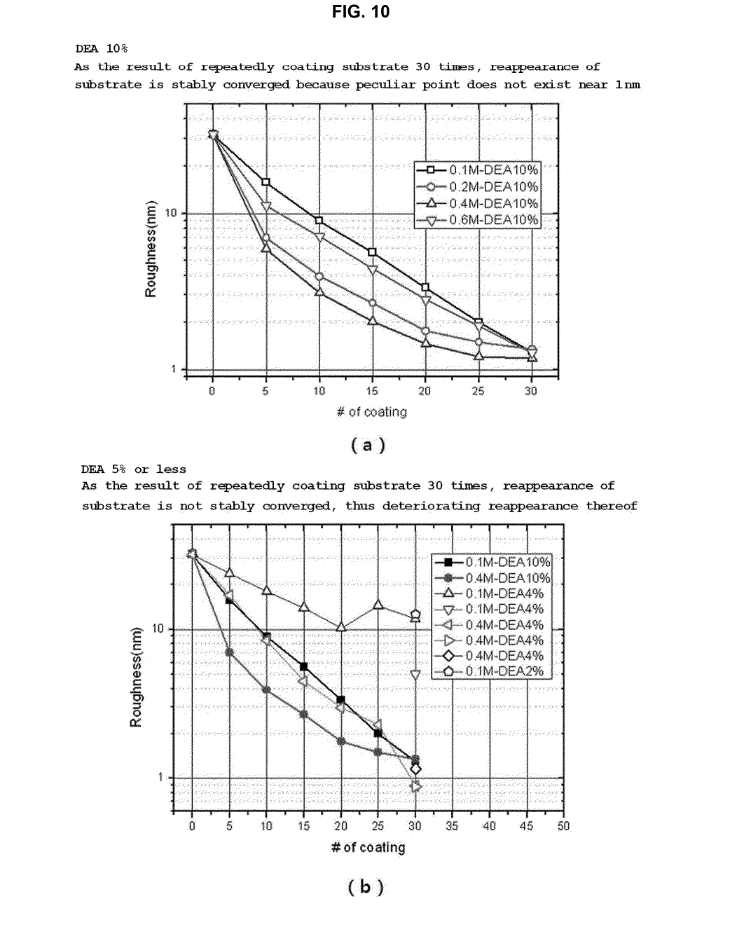

FIG. 1 is a process view showing a method of preparing a yttrium solution for a buffer layer of a substrate according to the present invention, FIG. 2 is a schematic view showing a deposition apparatus for depositing a yttria sol prepared by each Example of the present invention on a substrate, FIG. 3 shows atomic force microscope (AFM) images of a non-surface-treated hastelloy substrate depending on surface changes thereof, FIG. 4 shows AFM images of a substrate fabricated by Example 1 of the present invention depending on surface changes thereof, FIG. 5 shows AFM images of a substrate fabricated by Example 2 of the present invention depending on surface changes thereof, FIG. 6 shows AFM images of a substrate fabricated by Example 3 of the present invention depending on surface changes thereof, FIG. 7 is a graph showing the results of auger analysis of a substrate fabricated by Example 1 of the present invention, FIG. 8 is a graph showing the results of auger analysis of a substrate fabricated by Example 2 of the present invention, and FIG. 9 is a graph showing the results of auger analysis of a substrate fabricated by Example 3 of the present invention.

As shown in FIG. 1, the method of preparing a yttria solution for a buffer layer of a substrate according to the present invention includes the steps of: 1) mixing yttrium acetate tetrahydrate with methanol to form a mixture and then stirring the mixture; 2) injecting diethanolamine as a chelating agent into the mixture of the step 1) and then stirring the mixture to synthesize a composite; and 3) filtering the composite synthesized in the step 2) using a filter to obtain a sol.

First, in the step 1), yttrium acetate tetrahydrate is mixed with methanol to form a mixture, and then the mixture is stirred. The stirring of the mixture is performed at 50° C.˜60° C. for 30 minutes˜5 hours.

Subsequently, in the step 2), diethanolamine, as a chelating agent, is injected into the mixture of the step 1), and then this mixture is stirred to synthesize a composite. The diethanolamine is injected using a syringe, and the stirring of the mixture is performed at room temperature for 30 minutes˜5 hours.

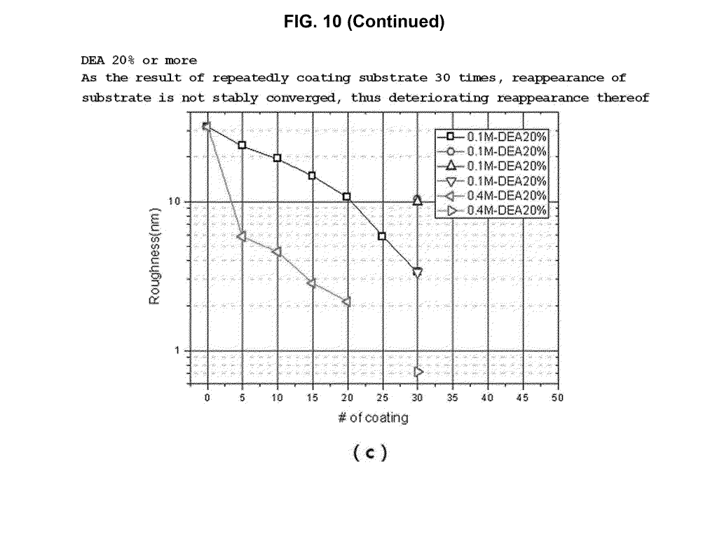

In the step 2), even when diethanolamine is injected in an amount of 5˜20% based on the volume of methanol, it is not sufficient to obtain desired results. As shown in FIG. 10, it can be ascertained that the continuous reappearance of a substrate cannot be realized during repetitive coating when the amount of diethanolamine is 5% or less and 20% or more.

Subsequently, in the step 3), the composite synthesized in the step 2) is filtered using a filter to obtain a sol, thereby preparing the yttria solution of the present invention.

Hereinafter, the present invention will be described in more detail with reference to the following Examples.

### EXAMPLE 1

In Example 1 of the present invention, yttrium acetate tetrahydrate (Alfa Aesar Chemical Co., 99.9%) was used as a basic starting material, and was directly used without being refined.

Methanol (methyl alcohol, Aldrich Chemical Co., 99%) was used as a solvent. 3.4 g (0.1 M) of yttrium acetate tetrahydrate was added to 90 mL of methanol to a mixture, and then the mixture was slowly stirred using a magnetic bar at a temperature of about 55° C. for about 1 hour.

Subsequently, 10 mL of diethanolamine, serving as a chelating agent, was slowly injected into the mixture using a syringe, and then this mixture was stirred at room temperature for 2 hours to synthesize a composite.

Finally, the synthesized composite was filtered by a polytetrafluoroethylene (PTFE) syringe filter having a pore size of 0.22 μm to obtain a sol.

### EXAMPLE 2

In Example 2 of the present invention, yttrium acetate tetrahydrate (Alfa Aesar Chemical Co., 99.9%) was used as a basic starting material, and was directly used without being refined.

Methanol (methyl alcohol, Aldrich Chemical Co., 99%) was used as a solvent. 13.6 g (0.4 M) of yttrium acetate tetrahydrate was added to 90 mL of methanol to a mixture, and then the mixture was slowly stirred using a magnetic bar at a temperature of about 55° C. for about 1 hour.

Subsequently, 10 mL of diethanolamine, serving as a chelating agent, was slowly injected into the mixture using a syringe, and then this mixture was stirred at room temperature for 2 hours to synthesize a composite.

Finally, the synthesized composite was filtered by a polytetrafluoroethylene (PTFE) syringe filter having a pore size of 0.22 μm to obtain a sol.

### EXAMPLE 3

In Example 3 of the present invention, yttrium acetate tetrahydrate (Alfa Aesar Chemical Co., 99.9%) was used as a basic starting material, and was directly used without being refined.

Methanol (methyl alcohol, Aldrich Chemical Co., 99%) was used as a solvent. 20.4 g (0.6 M) of yttrium acetate tetrahydrate was added to 90 mL of methanol to a mixture, and then the mixture was slowly stirred using a magnetic bar at a temperature of about 55° C. for about 1 hour.

Subsequently, 10 mL of diethanolamine, serving as a chelating agent, was slowly injected into the mixture using a syringe, and then this mixture was stirred at room temperature for 2 hours to synthesize a composite.

Finally, the synthesized composite was filtered by a polytetrafluoroethylene (PTFE) syringe filter having a pore size of 0.22 μm to obtain a sol.

In Examples 1, 2 and 3, each of the sols was finally obtained in the same manner, except that the amount (number of moles) of yttrium acetate tetrahydrate added in each Example was changed.

Next, each of the sols obtained in Examples 1 to 3 was deposited on a substrate, and then the physical properties of the substrate were measured. This procedure will be described in detail as follows.

As the substrate for depositing a yttria sol, a hastelloy C-276 metal tape having a thickness of 0.05 mm and a length of 230 cm was used.

As the deposition apparatus of the present invention, a deposition apparatus using a reel-to-reel method was used, as shown in FIG. 2.

The deposition apparatus includes a bath 200 for containing a solution, a quartz furnace 300 for heating a metal substrate 100 to deposition temperature, a tensioner for adjusting the tension of a wire rod, and a motor for continuously coating the wire rod.

As the bath 200 for containing a solution, a teflon-made beaker, which is not influenced by a solution, was used.

The quartz furnace 300 for heat-treating the solution applied on the metal substrate 100 is configured to have a diameter of 30 mm and a length of 300 mm in order for the quartz furnace to be slightly influenced by heat. Further, the quartz furnace 300 is configured such that heating temperature can be controlled to 900° C.

The deposition apparatus may further include an air gas connection pipe in order to make an oxygen atmosphere.

The motor (not shown) is provided for the purpose of continuously coating a wire rod, and can control a rotation speed (rpm). The tensioner 400 is provided in order to adjust the tension of the heat-treated wire rod with respect to its expansion.

In order to form a Y2O3 buffer layer using this deposition apparatus, the deposition of the Y2O3 buffer layer is conducted by a dip coating method using a continuous tape loop coater such that a wire rod is dipped into the bath 200 and then repeatedly heat-treated.

As the substrate 100, a metal tape having an RMS roughness of 67 nm on a scale of 20 μm×20 μm and having an RMS roughness of 31.8 nm on a scale of 5 μm×5 μm was used.

The metal tape, as the substrate 100, moves at a speed of 100 mm per minute.

The bath 200 for dip coating includes a pulley which can be freely rotated such that the metal tape is immersed into a solution, a container which can contain the solution, and an inlet and an outlet through which the solution is introduced into the container or the metal tape is transported. When the metal tape coated with solution is introduced into the quartz furnace 300, in which fluid flow is controlled in order to prevent fluid from being shaken during solvent drying, Y2O3 conversion sequentially takes place in the quartz furnace 300, and hydrocarbon oxidation takes place in the quartz furnace 300 at a temperature of 500° C.±10.

Dry compressed air having a flow rate of 63 mL/min serves to sufficiently oxidize hydrocarbons and remove side-products from the quartz furnace 300. Further, multiple coating is performed by consecutive coating procedures using a loop coater.

Each thin film was formed by filling a bath with each of the Y2O3 solutions prepared in Examples 1 to 3 and then depositing this Y2O3 solution on a substrate using the deposition apparatus shown in FIG. 2.

The deposition of the Y2O3 solution is conducted several times to form a thin film having 30 layers or less.

The physical properties of each of the thin films were measured as follow.

1. Analysis of Surface Roughness

FIG. 3 shows atomic force microscope (AFM) images of four portions of a non-surface-treated hastelloy substrate depending on surface changes thereof. As shown in FIG. 3, this substrate has an average surface roughness (Rrms) of 31.8 nm on a scale of 5 μm×5 μm.

FIG. 4 shows AFM images of a substrate coated with the solution prepared in Example 1 of the present invention depending on surface changes thereof. (a) of FIG. 4 shows an AFM image of the substrate deposited 5 times, (b) of FIG. 4 shows an AFM image of the substrate deposited 10 times, (c) of FIG. 4 shows an AFM image of the substrate deposited 15 times, (d) of FIG. 4 shows an AFM image of the substrate deposited 20 times, (e) of FIG. 4 shows an AFM image of the substrate deposited 25 times, and (f) of FIG. 4 shows an AFM image of the substrate deposited 30 times. From FIG. 4, it can be ascertained that the surface roughness of the substrate is decreased with the increase in the number of times of deposition.

FIG. 5 shows AFM images of a substrate coated with the solution prepared in Example 2 of the present invention depending on surface changes thereof. (a) of FIG. 5 shows an AFM image of the substrate deposited 5 times, (b) of FIG. 5 shows an AFM image of the substrate deposited 10 times, (c) of FIG. 5 shows an AFM image of the substrate deposited 15 times, (d) of FIG. 5 shows an AFM image of the substrate deposited 20 times, (e) of FIG. 5 shows an AFM image of the substrate deposited 25 times, and (f) of FIG. 5 shows an AFM image of the substrate deposited 30 times. From FIG. 5, it can be ascertained that the surface roughness of the substrate is decreased with the increase in the number of times of deposition.

FIG. 6 shows AFM images of a substrate coated with the solution prepared in Example 3 of the present invention depending on surface changes thereof. (a) of FIG. 6 shows an AFM image of the substrate deposited 5 times, (b) of FIG. 6 shows an AFM image of the substrate deposited 10 times, (c) of FIG. 6 shows an AFM image of the substrate deposited 15 times, (d) of FIG. 6 shows an AFM image of the substrate deposited 20 times, (e) of FIG. 6 shows an AFM image of the substrate deposited 25 times, and (f) of FIG. 6 shows an AFM image of the substrate deposited 30 times. From FIG. 6, it can be ascertained that the surface roughness of the substrate is decreased with the increase in the number of times of deposition.

As described above, when the yttria solution of the present invention is deposited on a substrate, the surface roughness of the substrate is decreased with the increase in the number of times of deposition. Therefore, if the yttria solution is applied onto the substrate while adjusting the number of times of deposition, a thin film having desired surface roughness can be formed, and the surface of the substrate can be flattened.

2. Analysis of Buffer Layer

Auger analysis was carried out in order to ascertain whether or not each of the thin films of Examples 1 to 3 can serve as a buffer layer.

FIG. 7 is a graph showing the results of auger analysis of the thin film of Example 1, which was obtained by depositing the yttria solution on a hastelloy substrate 30 times. From FIG. 7, it can be ascertained that nickel, which is a constituent of the hastelloy substrate, is detected with the passage of time. This means that the number of times of deposition of the thin film of Example 1 must be increased.

FIG. 8 is a graph showing the results of auger analysis of the thin film of Example 2, which was obtained by depositing the yttria solution on a hastelloy substrate 30 times. From FIG. 8, it can be ascertained that nickel, which is a constituent of the hastelloy substrate, is not detected at all with the passage of time, and that the thin film of Example 2 can serve as a buffer layer even when the deposition of the yttria solution is performed about 30 times.

FIG. 9 is a graph showing the results of auger analysis of the thin film of Example 3, which was obtained by depositing the yttria solution on a hastelloy substrate 30 times. From FIG. 9, it can be ascertained that nickel, which is a constituent of the hastelloy substrate, is not detected at all with the passage of time, and that the thin film of Example 3 can serve as a buffer layer even when the deposition of the yttria solution is performed about 30 times.

As described above, in the case where the yttria solution of the present invention is deposited on a substrate to form a thin film, the thin film can serve as a buffer layer when the number of times of deposition of the yttria solution is adjusted.

The method of the present invention is advantageous in that the yttria solution prepared in this method is applied onto a substrate to flatten the substrate, and is used to form a diffusion barrier serving as a buffer layer for preventing the diffusion of a substrate material.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of preparing a yttria solution for a buffer layer of a substrate, comprising the steps of:
(a) mixing yttrium acetate tetrahydrate with methanol to form a mixture and then stirring the mixture;
(b) injecting diethanolamine as a chelating agent into the mixture of the step (a) and then stirring the mixture to synthesize a composite; and
(c) filtering the composite synthesized in the step (b) using a filter to obtain a sol.

2. The method of claim 1, wherein the step (a) is performed at 50° C.˜60° C. for 30 minutes˜5 hours.

3. The method of claim 1, wherein, in the step (b), diethanolamine is injected in an amount of 5˜20 vol % based on the volume of methanol.

4. The method of claim 1, wherein, in the step (b), diethanolamine is injected using a syringe.

5. The method of claim 1, wherein the step (b) is performed at room temperature for 30 minutes˜5 hours.

6. The method of claim 1, wherein, in the step (c), the composite is filtered using a syringe filter.

7. The method of claim 1, wherein the sol is deposited on a substrate.

8. The method of claim 7, wherein the substrate is a hastelloy substrate.

9. The method of claim 8, wherein the deposition of the sol is performed by dip coating.

10. The method of claim 7, wherein the deposition of the sol is performed two or more times.
